(19) United States
(12) Patent Application Publication
(10) Pub. No.: US 2012/0024114 A1
(43) Pub. Date: Feb. 2, 2012

(54) BATTERY OPERATED TATTOO GUN

(76) Inventor: Alejandro Vazquez, Lebanon, PA (US)

(21) Appl. No.: 12/848,161

(22) Filed: Jul. 31, 2010

(51) Int. Cl. A01K 11/00

(52) U.S. Cl. 81/9.22

(57) ABSTRACT

A tattoo gun for applying body art to a recipient's skin comprising: an oscillating needle, where the needle penetrates the skin for application of ink; a coil assembly; and a battery pack, where said batter pack is used as the power source for the tattoo gun. The battery pack is a rechargeable battery pack that allows for the cordless operation of the tattoo gun.

### BACKGROUND OF THE INVENTION

1. Field of Invention

The present invention relates to a battery-operated cordless tattoo gun.

2. Description of Related Art

Body art specifically tattoos are popular designs that are permanently etched onto an individual's skin. The popularity of tattoos has increased over recent years and it has become quite common to see many individuals have multiple tattoos on various body parts. The type and style of tattoos are based upon individual choice and may be created from a grouping of predetermined art or custom designed by the recipient.

A tattoo artist uses various tools and in particular a tattoo gun to apply the tattoo onto the skin of an individual. Tattoo guns are comprised of an oscillating needle and a set of coils that are used to inject ink into the skin. The tattoo gun must produce consistent oscillations of the needle in order to provide a consistent injection of ink over the skin. Many times the tattoo artist must draw lines and do shading in order to accurately complete the body art being applied to the skin.

The modern tattoo gun is based upon earlier inventions of tattoo guns that date back to the late 1800s. The first known tattoo gun was patented by Thomas Edison in 1976, see U.S. Pat. No. 196,747. The concept was later modified and a dual coil tattoo gun was developed by Percy Juarez, see U.S. Pat. No. 1,724,812. Another more recent development of tattoo guns is disclosed in U.S. Pat. No. 4,159,659 to Carol Nightengale which made substantial modifications to the frame of the tattoo gun.

As noted above, tattoo guns require oscillation of the needle in order to penetrate the skin and apply ink into the skin of the recipient of the body art. The tattoo gun is an electrically powered device and is normally plugged into an AC outlet to supply electrical power to operate the oscillation of the needle and the movement of ink through the tattoo gun. The wire extending from the gun may sometimes be cumbersome and inhibit the tattoo artist's ability to maneuver the gun in certain positions while applying the body art onto the skin. It is therefore desirable to develop wireless or battery-operated tattoo guns that help to increase the maneuverability of the gun while the tattoo artist applies the body art. Use of a tattoo gun without a cord helps to allow the tattoo artist to more freely create the tattoo upon the skin.

### SUMMARY OF THE INVENTION

The present invention relates to a tattoo gun for applying body art to a recipient's skin comprising: an oscillating needle, where the needle penetrates the skin for application of ink; a coil assembly; and a battery pack, where said batter pack is used as the power source for the tattoo gun. The battery pack is a rechargeable battery pack that allows for the cordless operation of the tattoo gun.

### DESCRIPTION OF DRAWINGS

FIG. 1 depicts a battery-operated rechargeable tattoo gun according to the present invention.

### DETAILED DESCRIPTION

The present invention relates to a tattoo gun that utilizes a battery pack as a power source. The tattoo gun according to the present invention is a cordless gun that enables the artist to more easily maneuver the gun while applying body art to the skin. Use of the battery-operated tattoo gun enables the artist to maneuver the gun more freely and eliminates the restriction that is associated with the use of electrical power cords that are presently used in many tattoo guns. The present invention further eliminates any drag or the necessity to use two hands while handling the gun while applying the body art.

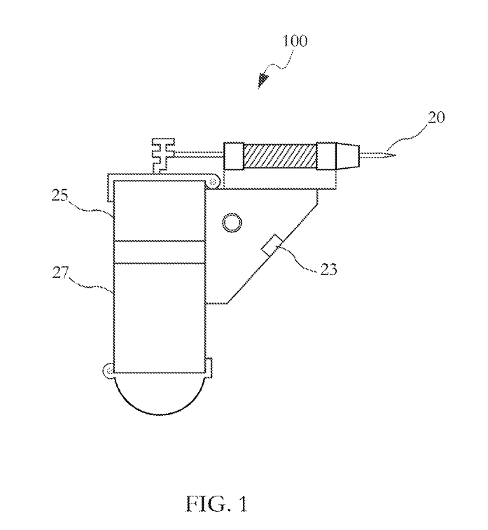

In reference to FIG. 1, a battery-operated tattoo gun 100 is depicted. The tattoo gun 100 according to the present invention includes an oscillating needle 20 and a coil assembly 25. The oscillating needle 20 is used for the application of ink onto the skin during the process of creating and applying a tattoo. The tattoo guns of the prior art typically include electrical cords that extend from the tattoo gun to supply power thereto. The tattoo gun 100 includes a battery pack 27 that is used as the power source for the tattoo gun 100. The battery pack 27 is a rechargeable battery pack that allows for the cordless operation of the tattoo gun 100. The advantage of using the battery pack 27 according to the present invention is the ability to replace the battery pack quickly once the charge wears down within the battery pack. A user of the tattoo gun 100 therefore may have a series of battery packs available while applying a tattoo to the skin of a recipient. In one particular embodiment, the battery pack 27 easily releases from the tattoo gun 100 and may be a replaced with a fully charged battery pack in order to continue smooth operation of the tattoo gun 100.

The battery pack 27 may also be charged by connecting a charger 23 to an AC outlet. Any suitable connection wire may be connected to the charger 23 to provide a means to supply power and charge the battery pack 27. Control buttons not shown are available on the tattoo gun 100 that will allow the user to turn the tattoo gun 100 on and off as necessary and to control the speed of oscillation of the needles 20. Use of the control means associated with the present invention alleviates the need for a foot pedal that is normally associated with a tattoo gun. The tattoo gun according to the present invention provides a wireless tattoo gun that enables the tattoo artist to freely maneuver the gun while applying ink to the skin of the recipient. The batter pack 27 is rechargeable and replaceable with a fully charged battery pack, therefore a series of battery packs can be available during the application of a tattoo. Once a battery pack is drained a replacement pack may be easily placed into the tattoo gun and therefore a consistent supply of adequate power is available for the tattoo gun during the application of a tattoo. The instant invention has been shown and described in what it considers to be the most practical and preferred embodiments. It is recognized, however, that departures may be made there from within the scope of the invention and that obvious modifications will occur to a person skilled in the art.

What is claimed is:

1. A tattoo gun for applying body art to a recipient's skin comprising:
a. an oscillating needle, where the needle penetrates the skin for application of ink;
b. a coil assembly; and
c. a battery pack, where said batter pack is used as the power source for the tattoo gun.

2. The tattoo gun according to claim 1, where the battery pack is a rechargeable battery pack that allows for the cordless operation of the tattoo gun.
